(19) United States
(12) Patent Application Publication
(10) Pub. No.: US 2008/0314657 A1
(43) Pub. Date: Dec. 25, 2008

(54) POWER SUPPLY APPARATUS

(75) Inventors: Tomohiro IKEDA, Shizuoka (JP); Takao Shoji, Shizuoka (JP); Shinichi Yanagihara, Shizuoka (JP); Kazuhisa Meguro, Aichi (JP); Yoshiaki Ichikawa, Shizuoka (JP)

Correspondence Address: KRATZ, QUINTOS & HANSON, LLP, 1420 K Street, N.W., Suite 400, WASHINGTON, DC, 20005, US

(73) Assignees: YAZAKI CORPORATION, Tokyo (JP); TOYOTA JIDOSHA KABUSHIKI KAISHA, Toyota-shi (JP)

(21) Appl. No.: 12/136,903

(22) Filed: Jun. 11, 2008

(30) Foreign Application Priority Data
Jun. 25, 2007 (JP) 2007-166767

(51) Int. Cl. B60K 1/02

(52) U.S. Cl. 180/65.1; 903/903

(57) ABSTRACT

The present invention is intended to provide a power supply apparatus which is sized down and lighter.

To attain the afore-mentioned objective, there is provided a power supply apparatus, comprising a battery aggregation including a plurality of batteries connected to each other in series, the battery having a positive electrode in its one end portion and a negative electrode in its opposite end portion, and an electrical junction box being disposed between a plurality of the batteries and being configured to allow connection and disconnection of the battery aggregation and a load outside the power supply apparatus.

### CROSS-REFERENCE TO RELATED APPLICATIONS

The present Application claims priority to Japanese Patent Application No. 2007-166767 filed on Jun. 25, 2007, the entire disclosure of which is expressly incorporated herein by reference.

### BACKGROUND OF THE INVENTION

(1) Field of the Invention

The present invention relates to a power supply apparatus used in a hybrid vehicle and an electric vehicle.

(2) Description of the Related Art

In a hybrid vehicle including both an internal combustion engine and an electric motor, or an electric vehicle including an electric motor, a power supply apparatus 101 as shown in FIG. 3 functions as a power source of the previously described electric motor. This power supply apparatus is, for example, disclosed in Japanese Publication of Un-examined Patent Application No. 2003-045409.

Referring to FIG. 3, the power supply apparatus 101 is shown to include a battery aggregation 103 comprising a plurality of secondary batteries 103 connected to each other in series and configured to supply electricity to the electric motor 104, and electrical junction box 102 being configured to allow connection and disconnection of the battery aggregation 103 and the electric motor 104.

A plurality of the secondary batteries 108 each is shown to include a body having the form of a rectangular parallelepiped, a positive electrode 106b projecting outwardly from one outer wall (i.e., a top wall) of the body 105 and disposed at one longitudinal end portion of the top wall and a negative electrode 106a projecting outwardly from the top wall of the body 105 and disposed at opposite longitudinal end portion of the top wall.

A plurality of the secondary batteries 108 is arranged in two rows along the longitudinal direction of the afore-mentioned top wall (i.e. a direction designated as an arrow “H” in FIG. 3) and is also arranged in sixteen rows across the width of the top wall (i.e. a direction designated as an arrow “N” in FIG. 3). As such, a plurality of the secondary batteries 108 is disposed such that the positive electrode 106a of one secondary battery is adjacent the negative electrode 106b of each neighboring secondary battery. These different type of electrodes 106a and 106b are connected to each other via a bus bar 107. As used herein, the longitudinal direction of the top wall and the widthwise direction of the top wall are interchangeably used with H direction and N direction, respectively.

Among these secondary batteries, two neighboring batteries 108 lie in the middle of the battery aggregation 103 in N direction, and are connected to each other via a circuit breaker 121. In further detail, the circuit breaker 121 is disposed in the vicinity of one end portion of the battery aggregation 103 in N direction, and is connected to the tip portion of respective electrical wires W2 and W3. These electrical wires W2 and W3 are also respectively connected to the foregoing two secondary batteries 108 at their opposite tip portions. The circuit breaker 121 can block the circuit between these two batteries when overcurrent flowing therebetween. As such, the circuit breaker 121 can function as an overcurrent protective device.

The electrical junction box 102 comprises a plurality of electrical parts such as a relay 220 and a fuse 222 accommodated by a housing, and is disposed in the vicinity of one end portion of the battery aggregation 103 in N direction. The electrical junction box 102 is connected via an electrical wire W1 to a positive electrode 106b of the battery 108, the battery 108 being disposed in the vicinity of one end portion of the battery aggregation 103 in N direction, and is also connected via an electrical wire W4 to as negative electrode 106a of the battery 108, the battery being disposed in the vicinity of an opposite end portion of the battery aggregation 103 in N direction. The electric motor 104 is connected via an electrical wire 9 to the electrical junction box 102. In other words, the electric motor 104 is connected via the electrical junction box 102 to the battery aggregation 103.

In the construction of the battery aggregation 103 having a plurality of the batteries 108 being connected to each other therein, a current flows from one end portion to an opposite end portion specifically along the arrow C′ in the battery aggregation 103. In further detail, in battery aggregation 103, current flows from the battery 108 connected to the electrical wire W1 (with reference to FIG. 3, nearest side from a viewer) toward the battery 108 connected to the electrical wire W4 (with reference to FIG. 3, most remote side from a viewer).

Since the afore-mentioned power supply apparatus 101 has the electrical junction box 102 being remote from the other end portion of the battery aggregation 103 in N direction, thereby resulting in a relatively long electrical wire 4W connecting between the electrical junction box 102 and the other end portion of the battery aggregation 103. To the end, the electrical wiring operation becomes complex. Further, there is needed a large-sized power supply apparatus for receiving such a relatively long electrical wire W4 as well as electrical wires W2 and W3 engaging with the circuit breaker 121.

### SUMMARY OF THE INVENTION

To solve the aforementioned problems, the present invention is intended to provide a power supply apparatus, comprising a battery aggregation including a plurality of batteries connected to each other in series, the battery having a positive electrode in its one end portion and a negative electrode in its opposite end portion, and an electrical junction box being disposed between a plurality of the batteries and being configured to allow connection and disconnection of the battery aggregation and a load outside the power supply apparatus.

Preferably, the battery aggregation is divided into two groups of the batteries, and two groups of the batteries are disposed adjacent to the electrical junction box such that the positive electrode of the battery belonging to one group of the batteries is located close to the negative electrode of the battery belonging to the other group of the batteries and vice versa.

Preferably, the electrical junction box is located in the middle of the battery aggregation so as to divide the battery aggregation into two groups of the batteries, and each of the batteries being adjacent to the electrical junction box and belonging to either of two groups of the batteries is connected via a connection member to the electrical junction box.

### BRIEF DESCRIPTION OF THE DRAWINGS

FIG. 1 is a perspective view of an embodiment of a power supply apparatus in accordance with the present invention.

FIG. 2 is a plan view of the power supply apparatus of FIG. 1.

FIG. 3 is a perspective view of an exemplary conventional power supply apparatus.

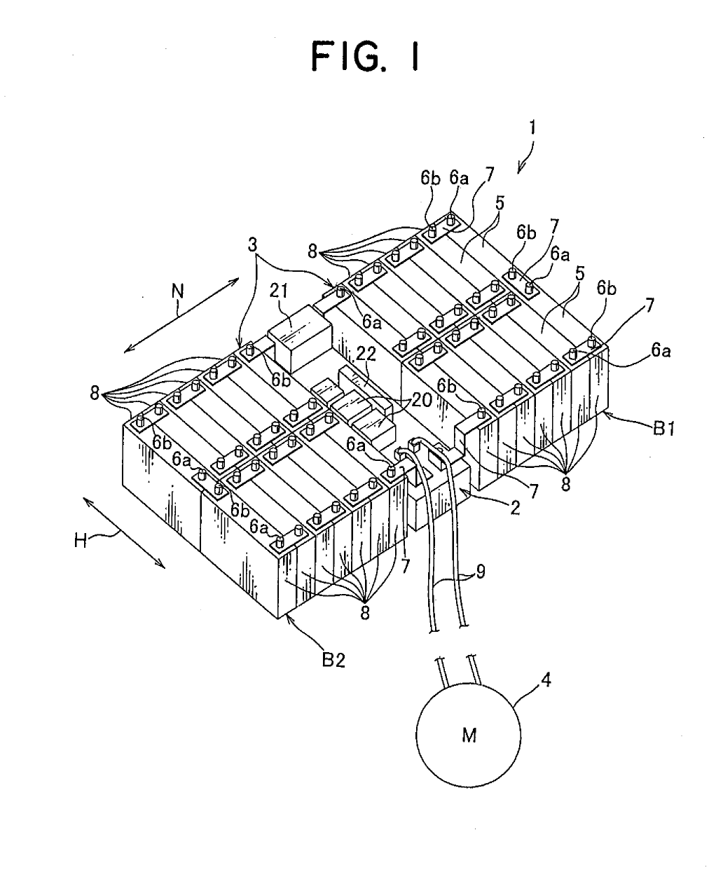

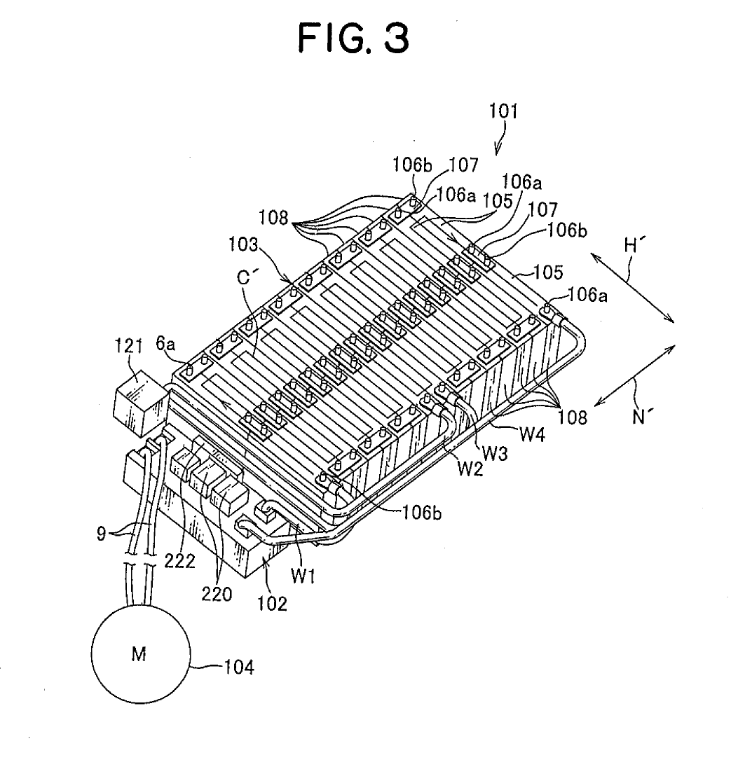

The foregoing summary, as well as the following detailed description of certain embodiments of the present invention, will be better understood when read in conjunction with the appended FIGS. 1 to 3. For the purpose of illustrating the invention, there is shown in the drawings, certain embodiments. It should be understood, however, that the present invention is by no means limited by the appended drawings.

### DESCRIPTION OF THE PREFERRED EMBODIMENTS

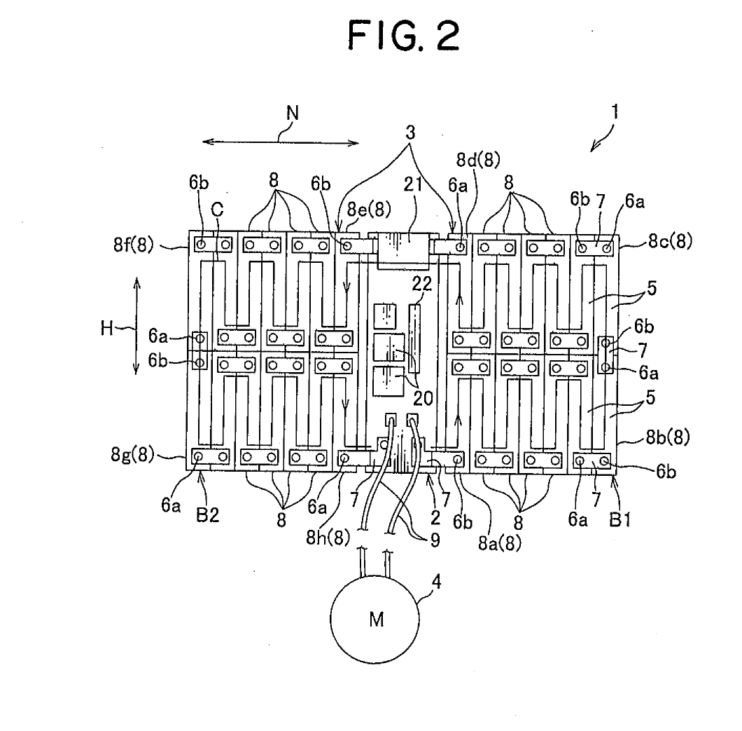

Referring now to FIGS. 1 and 2, an embodiment of a power supply apparatus in accordance with the present invention will be illustrated in detail. FIG. 1 is a perspective view of an embodiment of a power supply apparatus in accordance with the present invention. FIG. 2 is a plan view of the power supply apparatus of FIG. 1.

The power supply apparatus 1 is mounted to an electric vehicle using an electric motor to propel the vehicle, or a hybrid vehicle using an internal combustion engine and an electric motor to propel the vehicle, and is configured to provide the electric motor with electricity. With reference now to FIG. 1, such a power supply apparatus 1 comprises a battery aggregation 3, and an electrical junction box 2 allowing connection and disconnection of the battery aggregation 3 and the electric motor 4 (i.e., a load or a driving unit connected to the battery aggregation 3). Further, the power supply apparatus 1 may be further connected to an alternator as needed. When used herein, the term “battery” or “batteries” can be interchangeably used with the term “secondary battery” or “secondary batteries”.

Referring to FIG. 1, the battery aggregation 3 is shown to include a first group of batteries B1 including a plurality of second batteries connected to each other in series, and a second group of batteries B2 including a plurality of second batteries connected to each other in series. The number of second batteries consisting of the second group B2 is equivalent of that of the second batteries consisting of the first group B1. In this construction, the first group B1 and the second group B2 are connected to each other in series via an electrical junction box 2. Further, the first group of the batteries B1, the electrical junction box 2, and the second group of the batteries B2 are aligned with one another. A direction where the first group of the batteries B1, the electrical junction box 2, and the second group of the batteries B2 are aligned with is hereinafter designated as an “alignment direction”, and is also indicated by an arrow “N” in FIGS. 1 and 2. There is also provided a direction that is perpendicular to the afore-mentioned alignment direction. This direction is hereinafter designated as “perpendicular direction” and is also indicated by an arrow “H” in FIGS. 1 and 2. Ni this regard, the previously described “alignment direction” and “perpendicular direction” can also be hereinafter called as “N direction” and “H direction”, respectively.

Each of the secondary batteries 8 is shown to include a body 5 having a form of a rectangular parallelepiped, a cylindrically-shaped positive electrode 6b, and a cylindrically-shaped negative electrode 6a. Each of electrodes 6a and 6b has an end portion being disposed in the body 5 and the opposite end portion projecting outwardly from an outer wall (i.e. a top wall) of the body 5.

In both first group of batteries B1 and the second group of batteries B2, a plurality of the batteries 8 is disposed such that the positive electrode 6a of one secondary battery is adjacent to the negative electrode 106b of each neighboring secondary battery. These different type of electrodes 106a and 106b are connected to each other via a connection member such as a plate-type bus bar 7. Further, the bus bar 7 can be achieved by pressing an electrically conductive sheet metal and has two through-holes configured to pass the electrodes 6a and 6b therethrough.

With reference to FIGS. 1 and 2, the first group of the batteries B1 and the second group of the batteries B2 each has a common construction that a plurality of batteries 8 is connected to each other in series. In other words, in both first and second groups of the batteries B1 and B2, the batteries 8 are disposed such that the longitudinal direction of the outer wall (i.e., the top wall) of the battery 8 corresponds to the afore-mentioned perpendicular direction (i.e., H direction). The electrodes 6a and 6b each project outwardly from the afore-mentioned outer wall (i.e. the top wall) of the electrode 8. Each of groups of batteries B1 and B2 includes 7 rows of batteries in the alignment direction (i.e. N direction) and 2 rows of batteries in the perpendicular direction (i.e. H direction).

Further, the nearest-neighboring batteries 8 are disposed such that one type of electrode lies next to the opposite type of electrode. These neighboring different electrodes 6a and 6b are directly connected to each other via the bus bar 7. In the case of the electrodes being most remote from the electrical junction box 2 (i.e., the electrodes 8b, 8c, 8f, and 8g as shown in FIG. 2), the positive electrode 6b of the battery 8c and the negative electrode 6a of the battery 8b are aligned with each other in the middle area along the perpendicular direction (i.e. H direction), and are connected to each other via the bus bar 7. In the similar manner, the negative electrode 6a of the battery 8f and the positive electrode 6b of the battery 8g are aligned with each other in the middle area along the perpendicular direction (i.e. H direction), and are connected to each other via the bus bar 7. On the other hand, the negative electrode 6a of the battery 8c or 8g and the positive electrode 6b of the battery neighboring the same battery 8c or 8g in the alignment direction are connected via the bus bar 7 to each other. In the similar manner, the positive electrode 6b of the battery 8b or 8f and the negative electrode 6a of the battery neighboring the same battery 8b or 8f in the alignment direction are connected via the bus bar 7 to each other.

Referring now to FIG. 2, in both the first and second groups of the batteries B1 and B2, the batteries being most adjacent to the electrical junction box 2 (i.e. the batteries 8a, 8d, 8e, and 8h) each are disposed such that its one electrode is connected via the bus bar 7 to the opposite electrode of the battery neighboring the associated battery in the alignment direction, and its remaining electrode (i.e., its opposite electrode) is connected to the electrode formed in the electrical junction box 2. In further detail, the positive electrode 6b of each battery 8a and 8e is connected to the electrode formed in the electrical junction box 2, and the negative electrode 6a of each battery 8d and 8h is connected to the electrode formed in the electrical junction box 2. The previously described connection between two electrodes is also carried out by the bus bar 7.

In the afore-mentioned battery aggregation 3, a current flows from the positive electrode 6b of the battery 8a belonging to the first group of the batteries B1 toward the negative electrode 6a of the battery 8d. Such current in turn flows from the negative electrode 6a of the battery 8d via the electrical junction box 2 toward the positive electrode 6d of the battery 8e belonging to the second group of batteries B2. This current in turn flows from the positive electrode 6d of the battery 8e toward the negative electrode 6a of the battery 8h within the second group of batteries B2. This current flow can be indicated by “C” in FIG. 2.

In further detail, the positive electrode 6b of the battery 8a belonging to the first group of the batteries B1 comprises one end portion of the first group of the batteries B1 and the battery aggregation 3. Further, the negative electrode 6a of the battery 8d belonging to the first group of the batteries B1 comprises the other end portion (i.e., an opposite end portion) of the first group of the batteries B1. In the same manner, the positive electrode 6b of the battery 8e belonging to the second group of the batteries B2 comprises one end portion of the second group of the batteries B2. In addition, the negative electrode 6a of the battery 8h belonging to the second group of the batteries B2 comprises the other end portion (i.e., an opposite end portion) of the second group of the batteries B2. As used herein, the terms “one end portion” or “the other end portion (or an opposite end portion)” is not intended to indicate either or both end portion along any linear direction of the associated subject, but is intended to indicate either the most-upstream portion or the most-downstream portion of the electric circuit with respect to the afore-mentioned current flow. Further, the interface between the negative electrode 6a of the battery 8d and the positive electrode 6b of the battery 8e corresponds to the term “electrical-middle area” of the battery aggregation 3 as described in claims appended below.

The electrical junction box 2 includes a variety of the electrical parts such as a rely 20, a fuse 22, and a circuit breaker 21 carried by a housing. The relay 20 usually operates in accordance with signal transmitted from the control circuit (not shown), and is configured to allow connection and disconnection between the battery aggregation 3 and the electric motor 4. When overcurrent flows between the battery aggregation 3 and the electric motor 4, the fuse 22 can block the circuit therebetween. The circuit breaker 21 is connected to both bus bars 7 where one is connected to the negative electrode 6a of the battery 8d belonging to the first group of the batteries B1 and the other is connected to the positive electrode 6b of the battery 8c to the second group of the batteries B2. When overcurrent flows between the batteries 8d and 8e, the circuit breaker 21 can block the circuit therebetween. The electrical junction box 2 has a connector holder being configured to engage with a connector which is formed in one end portion of the electrical wire 9, the electrical wire 9 having the other portion connected to the electric motor 4.

In accordance with the aforementioned power supply apparatus 1, the shorter each of the distance between the electrical junction box 2 and one end portion of the first group of the batteries B1 (i.e., the positive electrode 6b of the battery 8a), distance between the electrical junction box 2 and the other end portion of the first group of the batteries B1 (i.e., the negative electrode 6a of the battery 8d), the distance between the electrical junction box 2 and one end portion of the second group of the batteries B2 (i.e., the positive electrode 6b of the battery 8e), and the distance between the electrical junction box 2 and the other end portion of the second group of the batteries B2 (i.e. the negative electrode 6a of the battery 8h) becomes, the shorter the connection member configured to connect therebetween becomes. In other words, owing to this embodiment of the power supply apparatus 1, the amount of the connection member to be used can be largely cut down. For the reasons set forth above, the power supply apparatus 1 can be sized-down, be made lighter, and be economically prepared. In addition, since two objects to be connected to each other are closely situated, a bus bar can be utilized as a connection member connecting therebetween, thereby allowing for more simple electrical wiring operation.

Further, since the circuit breaker 21 is built or incorporated in the battery aggregation 3 by means of the bus bar 7, the power supply apparatus 1 can be further sized-down, be made lighter, and be economically prepared, thereby allowing for more simple electrical wiring operation.

While the foregoing embodiment of the power supply apparatus in accordance with the present invention has the electrical junction box 2 in the middle of the battery aggregation 3, the electrical junction box may be disposed in any position within the power supply apparatus. For example, the electrical junction box may be disposed between the batteries 8.

In the foregoing embodiment of the power supply apparatus in accordance with the present invention, there is provided a construction that the other end portion of the first group of the batteries B1 (i.e., the negative electrode 6a of the battery 8d) and the one end portion of the second group of the batteries B2 (i.e., the positive electrode 6b of the battery 8e) are connected to each other via the circuit breaker 21 within the electrical junction box 2. However, the present invention also provides a construction that the negative electrode 6a of the battery 8d and the positive electrode 6b of the battery 8e is directly connected to each other via the bus bar 7. The circuit breaker 21 may be disposed in any position within the power supply apparatus. For example, the circuit breaker 21 may be disposed between the batteries.

While the foregoing embodiment of the power supply apparatus in accordance with the present invention employs the bus bar 7 as a connection member, the bus bar 7 may be substituted with an electrical wire. In a case where an electrical wire is used as a connection member, the amount of electrical wire to be used can be largely cut down, resulting in small-sized, lighter power supply apparatus 1.

Further, it is possible to mount a voltage detection device on the electrical junction box 2 in the power supply apparatus in accordance with the present invention. In some detail, the voltage detection device is provided to detect the total voltage of the battery aggregation 3, and the voltage of each group of batteries B1 and B2 (i.e., the part voltage of the battery aggregation 3). In this case, the afore-mentioned voltage detection device can be positioned in the four bus bar 7 each connecting between the battery (i.e. one of batteries 8a, 8d, 8e, and 8h) and the electrical junction box 2. As such, the total voltage and the part voltage of the battery aggregation 3 can be detected, and therefore the voltage detection device can be further simplified. Also, because the batteries 8a, 8d, 8e, and 8h are located close to each other, the connection member of the voltage detection device to be used can also be largely cut down.

Changes and modifications in the specifically described embodiments would come within the scope of the invention, which is intended to be limited only by the scope of the appended claims, as interpreted according to the principles of patent law.

What is claimed is:

1. A power supply apparatus, comprising:
a battery aggregation including a plurality of batteries connected to each other in series, the battery having a positive electrode in its one end portion and a negative electrode in its opposite end portion, and
an electrical junction box being disposed between a plurality of the batteries and being configured to allow connection and disconnection of the battery aggregation and a load outside the power supply apparatus.

2. The power supply apparatus according to claim 1, wherein the battery aggregation is divided into two groups of the batteries, and the two groups of the batteries are disposed adjacent to the electrical junction box such that the positive electrode of the battery belonging to one group of the batteries is located close to the negative electrode of the battery belonging to the other group of the batteries and vice versa.

3. The power supply apparatus according to claim 2, wherein the electrical junction box is located in the middle of the battery aggregation so as to divide the battery aggregation into the two groups of the batteries, and each of the batteries being adjacent to the electrical junction box and belonging to either of the two groups of the batteries is connected via a connection member to the electrical junction box.
